(19) United States
(12) Patent Application Publication
(10) Pub. No.: US 2022/0231583 A1
(43) Pub. Date: Jul. 21, 2022

(54) METHOD AND DEVICE FOR STRAIN MEASUREMENT ON A BODY LOADED WITH CENTRIFUGAL FORCE

(71) Applicant: Schenck RoTec GmbH, Darmstadt (DE)

(72) Inventors: Andreas BUSCHBECK, Bickenbach (DE); Matthias HARTNAGEL, Bensheim (DE); Constantin HILL, Darmstadt (DE)

(73) Assignee: Schenck RoTec GmbH, Darmstadt (DE)

(21) Appl. No.: 17/610,546

(22) PCT Filed: May 15, 2020
(86) PCT No.: PCT/DE2020/100424

§ 371 Date: Nov. 11, 2021

(30) Foreign Application Priority Data
May 17, 2019 (DE) 10 2019 113 154.5

(51) Int. Cl. H02K 15/02; G06T 7/11; G06T 7/00

(52) U.S. Cl. CPC H02K 15/02; G06T 2207/30164; G06T 7/001; G06T 7/11

(57) ABSTRACT

A strain of a rotor (2) loaded with centrifugal force is measured, whereby the rotor (2) is introduced into a receiving part of a spin test rig (1) that can be connected to a drive, a camera (4) and a short-term illumination unit (6) are triggered, and at least one region of a surface of the rotor (2) is photographed. This first image is transmitted to an evaluation unit (8) as a starting state. The rotor (2) is accelerated and, at at least one rotational speed, the camera and the short-term illumination unit (6) are triggered again and at least one further image of the previously photographed region of the surface is photographed, which is transmitted to the evaluation unit (8) as a measuring state. The evaluation unit (8) calculates a strain of the rotor (2) in the photographed region of the surface using a digital image correlation, wherein the exposure time of the image sensor of the camera (4) is determined from the duration of the illumination coming from the short-term illumination unit (6).

The invention relates to a method and a device for measuring a strain of a rotor loaded with centrifugal force in a spin test rig.

In order to measure loads that act on a rotating body, spin test rigs are used in which the body, such as a rotor, is operated in its operating rotational speed range and above. In addition, the rotor can, for example, be exposed to cyclical changes in rotational speed or temperature fluctuations.

In order to determine changes in the rotor, the expansion, i.e. the strain of the rotor, is measured using strain gauges, for example. The disadvantage here, however, is that the measurement is limited to individual measuring points and a full-surface measurement cannot be achieved. In addition, the application of the strain gauges is labourintensive and time-consuming and also requires wireless signal transmission for measurements on rotors. Furthermore, due to their size, strain measurements are not suitable on fine structures. In addition, they also cause an unintentional reinforcement of the structure to be examined, due to the adhesive bonding.

It is also known to take photographs of loaded bodies and to determine the loads using a digital image correlation. For example, EP 1 510 809 A1 discloses a device for testing products such as ampoules, in which a camera attached to a rotating camera tower generates images of a test specimen which are fed to a downstream evaluation system. The camera can rotate together with the test specimen or the test specimen can perform a complete rotation while the camera is pivoting, so that the entire surface of the test specimen is made accessible to the camera as a result.

WO 2010/089139 A1 describes a method in which the lens of a camera is directed to at least one optically detectable marking and the marking is imaged on a matrix sensor. The image data are supplied by an image processing device that performs image recognition, so that the position of the marking within the image field is determined, and a deviation of the position of the marking from at least one target value is determined by means of a computing device and is quantified based on the position of the marking within the image field.

DE 60 2006 000 063 T2 shows in-situ monitoring of a component for a turbine gas plant, wherein a camera and a light source are provided and the light source illuminates the rotating component while the camera receives an image of the component. The disadvantage of this procedure is the high financial outlay for providing two different, complex measuring systems for the measurement of displacements and shape detection.

A rotor blade for a wind turbine is shown in WO 2009/143848 A2. A plurality of light sources and light sensors are arranged on the rotor blade, wherein a change in position of the light sources associated with a rotation of the rotor blade can be detected by the sensors. A rotor blade for a wind turbine is known from WO 2009/143849 A2, on which a plurality of markers and light sensors are arranged. A change in the position of the markers associated with a rotation of the rotor blade can be detected by the sensors.

Furthermore, speckle interferometry allows a contactless and extensive detection of displacements and/or deformations on any components. 2D and 3D speckle interferometers are known with which the deformation can be determined in two or three coordinate axes. For this purpose, the components of the displacement of points on the surface in one or more directions are measured with the speckle interferometer and converted into the coordinate system of the object or a spatial coordinate system for a large number of points. Thus, EP 0 731 335 A shows such a method for determining undesired deformations of an object, which mostly occur under load, in which speckle interferometry is used according to the special method of shearography. However, the shape of the object is not determined in this case. The device has two separate cameras and a two-armed Mach-Zehnder interferometer.

DE 10 2006 012 364 A1 discloses a method for optically measuring the position states of at least one rotor component of a rotor. Here, the rotor is rotated about its axis of rotation and at least one rotor segment is illuminated in a stationary or pulsed manner with a light source and a video camera of a video stroboscope unit is focused on the illuminated segment. Depending on the position of the rotor component, a trigger signal is generated by means of a trigger sensor and the video stroboscope unit is controlled with the trigger signal in a phase-accurate manner and images are recorded by the camera.

DE 10 2013 110 632 A1 relates to a method for measuring the expansion of a rotating rotor, in which a distance sensor is arranged at a distance from the rotor and detects the distance between the rotor surface and the distance sensor in a contactless manner.

DE 10 2008 055 977 A1 describes a method and a device for determining the deformation of a rotating cutting tool, in which a radial expansion of the tool is determined. The device has a transmitter emitting a measuring beam and a receiver measuring the received intensity of the measuring beam, wherein the measuring beam runs tangentially along the circumferential surface of the rotating tool and the relative shadowing of the measuring beam can be measured with the receiver during the rotation of the tool. By means of a suitable arrangement of a plurality of transmitters and a plurality of receivers, a plurality of measuring beams can run along different regions of the rotating tool.

DE 195 28 376 A1 discloses a method for contactless measurement of a rotating tool in which optoelectronic measurement paths are used that measure an interruption of a light beam by a surface line of a tool moved into the measurement path by means of an associated photodiode.

The invention is based on the object of providing a cost-effective and simple strain measurement on bodies loaded with centrifugal force.

The object is achieved by the features of claim 1 and claim 8. Preferred embodiments are specified in the dependent claims.

The object is achieved according to the invention in that a method for measuring a strain of a rotor loaded with centrifugal force is provided, in which the rotor is introduced into a receiving part of a spin test rig that can be connected to a drive, a camera and a short-term laser as a short-term illumination unit are triggered, and at least one region of a surface of the rotor is photographed, and this first image is transmitted to an evaluation unit as a starting state, the rotor is accelerated and, at at least one rotational speed, the camera and the short-term laser as a short-term illumination unit are triggered again and at least one further image of the previously photographed region of the surface is photographed, which is transmitted to the evaluation unit as a measuring state, the evaluation unit calculates a strain of the rotor in the photographed region of the surface using a digital image correlation, wherein an exposure time of an image sensor of the camera is determined from the duration of the illumination coming from the short-term laser. The method according to the invention allows a simple and fast strain measurement on rotors having a small apparatus structure, especially since a complex synchronisation between the camera and the short-term illumination unit is not necessary. The rotor is illuminated in the starting state and in the measuring state exclusively by means of the illumination provided by the short-term illumination unit. The illumination is advantageously a light pulse from a short-term illumination unit, which is a short-term laser, in particular a pulse laser, such as a short-pulse laser or an ultra-short-pulse laser. By using a short-term illumination unit, a low degree of motion blur is achieved and the movement of the rotor is more or less frozen.

Furthermore, the method according to the invention allows a full-surface strain measurement of the observed measuring surface, since it is not restricted to individual measuring points like the known strain gauges. A plurality of images recorded in the measuring state and at different rotational speeds or images depicting different surface regions of the rotor can be synchronised with one another, so that the substantially entire rotor surface can be viewed.

In the context of the invention, a rotor is a rotating body.

In a preferred embodiment, the maximum circumferential speed to be observed determines the maximum permissible exposure time in order to keep the motion blur below an acceptable limit. Furthermore, this permissible limit can also be determined by the desired image resolution of the recording. In particular, higher resolutions require shorter exposure times.

It can be provided that when a reference mark applied to the surface of the rotor or the rotor receiving part, in particular the rotor receiving part adapter, is detected by a reference sensor, the triggering process of the camera and/or the short-term illumination unit is started. The referencing to the angle of rotation also allows the synchronisation of a plurality of recorded images. It is also advantageous if the triggering of the camera and/or the short-term illumination unit takes place with a delay in relation to the reference marker. A predeterminable angular offset can in this case be converted by means of the known rotational speed of the rotor into a delay or waiting period until the triggering of the camera and/or the short-term illumination unit takes place. This means that the rotor can be recorded in different angular positions.

The strain can be calculated in one embodiment in such a way that the evaluation unit compares images photographed in the measuring state with the image photographed in the starting state and calculates the strain of the rotor based on displacements of an optically recognisable surface pattern in the photographed region of the surface. The optically recognisable surface pattern forms, in particular, reference points based on which the displacement can be determined. On the one hand, the surface pattern can be formed by a natural surface structure of the rotor. This means that random but specific surface features of the measured rotor can be used to determine an influence of the centrifugal force on the rotor and thus any displacement of these natural surface features that may have occurred. This can be a groove in the rotor, for example. However, it can also be advantageous if the surface pattern is part of a marking applied to the rotor surface. In this case, it is advantageous if the surface pattern is resolved so finely that the strains to be observed are visible at all surface points.

Furthermore, it can be provided that graphic elements in the photographed region of a plurality of images are used to synchronise the images. Using the optically recognisable graphic elements, image portions recorded in an offset manner can be put together so that synchronisations with further image recordings for the representation of changes in strain are possible. The graphic elements can, for example, be applied in the form of rays, as a result of which offset image recordings (both translational and rotary) can be aligned with one another, in particular by bringing the ray-shaped markings into congruence. However, it is also possible to apply random patterns as graphic elements, such as, for example, colour markings, by means of which it is also possible to align a plurality of recordings with one another.

Furthermore, the invention relates to a device for measuring a strain of a rotor loaded with centrifugal force, comprising a spin test rig with receiving parts for receiving a rotor that can be connected to a drive in a rotating manner, a camera arranged at a distance from the rotor, which camera is arranged relative the rotor in such a way that images of at least one region of a surface of the rotor can be photographed, and a short-term laser provided as a short-term illumination unit for illuminating the rotor, wherein an exposure time of an image sensor of the camera can be determined from the duration of the illumination coming from the short-term laser. In a preferred embodiment, the device is used to carry out the method described above, so that the aforementioned embodiments and advantages can also be applied to the device. In the prior art, in addition to a high-speed camera, a complex illumination system is used to measure strains on bodies loaded with centrifugal force. The avoidance of motion blur is determined here by the shutter opening time of a high-speed camera, which also leads to resolution restrictions in the case of very short exposure times. In addition, the high-speed camera and the illumination system have to be synchronised in a complex manner. In the case of the device according to the invention, only a camera and a short-term illumination unit are used, wherein the rotor is illuminated only by the light provided by the short-term illumination unit, which freezes the movement of the rotor. This results in a low degree of motion blur. Another advantage is that a high image sharpness and thus a high spatial resolution can be achieved even at higher circumferential speeds of the rotor. In addition, due to the low equipment requirements, the device is significantly more cost-effective and economical than known systems.

In one embodiment it is provided that the device has positioning means which allow the position of the camera to be changed relative to the rotor. The distance between the camera and the rotor can be adjusted, for example, using the positioning means. A height-adjustable tripod, which supports the camera and can be arranged in the spin test rig, can be advantageous here. A corresponding camera holder can also be provided on the housing of the spin test rig. The distance between the camera and the rotor can be changed manually or automatically.

Using the method and the device according to the invention, the measurement of a radial expansion of a rotating body due to centrifugal force and thermal expansion is possible with simple equipment.

The invention will be explained in more detail with reference to embodiments of the invention, which are illustrated in the drawings, in which:

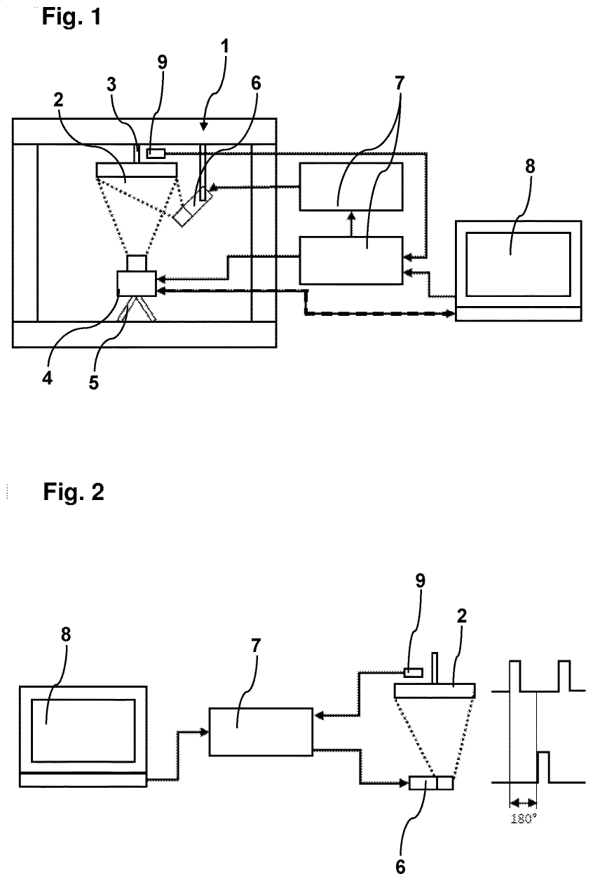

FIG. 1 shows an exemplary structure of a preferred device,

FIG. 2 shows a delayed triggering of the illumination,

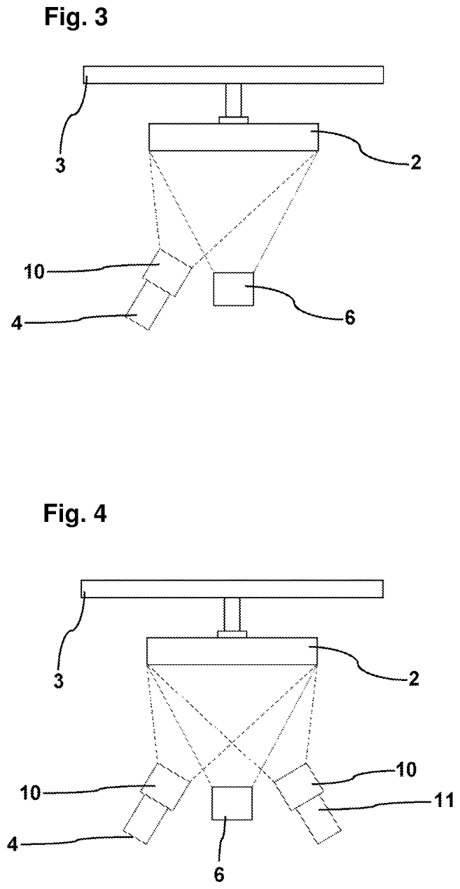

FIG. 3 shows an embodiment with a camera having a tilt adapter, and

FIG. 4 shows an embodiment with two cameras.

FIG. 1 shows an exemplary structure of a preferred device. A spin test rig 1 usually consists of a housing with a plurality of protective rings. A drive to which a rotor 2 to be measured can be connected is provided in the centre of the housing. For this purpose, the spin test rig 1 has corresponding bearings or adapters 3 which secure the rotor 2. In FIG. 1, the spin test rig 1 or its components are shown only schematically. Opposite the mounted rotor 2, a camera 4 is arranged at a distance from said rotor, specifically advantageously in such a way that the rotor surface can be recorded. The camera 4 can, for example, be attached to a holder 5 on the housing of the spin test rig 1. The holder 5 can in this case have positioning means which change the position of the camera 4 relative to the rotor 2 and, for example, allow the distance between the rotor 2 and the camera 4 to be changed and/or the camera 4 to be axially displaced in relation to the rotor 2. The positioning means can be manual or automatic, in particular electrical, pneumatic or hydraulic. An example of an electrical positioning means is a linear motor which allows the distance to be changed in a controlled manner. A tripod which is attached to the housing and has corresponding positioning means can also be useful for attaching or holding 5 the camera 4. The camera 4 can be a digital camera, for example.

A short-term illumination unit 6 for illuminating the rotor 2 is also attached to the housing. The short-term illumination unit 6 is preferably arranged relative to the rotor 2 in such a way that a surface of the rotor 2 facing the short-term illumination unit 6 is illuminated substantially uniformly. In addition, it is advantageous if the short-term illumination unit 6 does not protrude into the beam path of the camera 4, which is shown by the dashed lines. The camera 4 and the short-term illumination unit 6 can be connected to corresponding control and monitoring devices 7 which, for example, allow the triggering of the camera 4 and the short-term illumination unit 6 to be controlled. Furthermore, the camera 4 and the short-term illumination unit 6 are connected to an evaluation unit 8, which can be, for example, a computer, a tablet or any other processing unit. The control and monitoring devices 7 can also be controlled and monitored by means of the evaluation unit 8.

Using a sensor 9 arranged at a distance from the rotor, a reference signal applied, for example, to the rotor surface or the rotor receiving part adapter, for example a reference mark, can be detected in a contactless manner. This can be, for example, a magnetic sensor or a capacitive sensor, but also an optical mark.

To measure a strain of a rotor 2 loaded with centrifugal force, after the rotor 2 has been introduced into the receiving part 3, at least one recording of a starting state of the rotor 2 is made by triggering the camera 4 and the short-term illumination unit 6 and photographing at least one region of a surface of the rotor 2. This first recording is transmitted to the evaluation unit 8 as an image of the starting state. Of course, a plurality of such reference recordings can also be made by photographing a plurality of regions of the surface of the rotor 2.

The rotor 2 is then accelerated to a selectable rotational speed which, for example, can correspond to its operating rotational speed or a rotational speed above this. When the rotational speed or a rotational speed range is reached, the image recording by the camera 2 is achieved in particular in that the short-term illumination unit 6 is triggered again, the rotor 2 is illuminated and an image sensor of the camera 4 is exposed accordingly. A shutter of the camera 4 can already be brought into the open position before the rotating rotor 2 is photographed, in particular controlled by the control and monitoring devices 7. The triggering of the illumination by the short-term illumination unit 6 can be done with a delay for this purpose. Since there is no further light source in the spin test rig 1, the rotor 2 is illuminated exclusively by the short-term illumination unit 6. This means that only the illumination provided by the short-term illumination unit 6 is used for the exposure of the image sensor of the camera 4, wherein no complex synchronisation between the camera 4 and the short-term illumination unit 6 is necessary. The short-term illumination is in particular a light pulse from a laser.

The short-term illumination is advantageously chosen such that the movement of the rotor 2 appears to be more or less frozen for the desired spatial resolution, and a low degree of motion blur is achieved. If, for example, a motion blur of a maximum of 0.1 pixels at a maximum rotational speed of 20,000 rpm is desired, the duration of the illumination could be in a range from 15 nanoseconds to 25 nanoseconds. If, on the other hand, the motion blur should be a maximum of 2 pixels and the rotor speed is 15,000 rpm, the illumination could last around 30 to 40 nanoseconds. An illumination duration of less than 10 nanoseconds can be advantageous for high circumferential speeds and a desired motion blur of less than 0.1 pixels.

In the context of the invention, illumination of less than 100 nanoseconds can be referred to as short-term illumination, wherein the duration of illumination depends on the desired sharpness in the pixel or subpixel range and the circumferential speed of the rotor 2. This means that a desired spatial resolution requires a certain sharpness and thus results in a maximum short-term illumination duration for a desired circumferential speed. The higher the circumferential speed and the higher the desired sharpness or the lower the desired motion blur, the shorter the illumination duration of the short-term illumination unit 6 is advantageously configured to be.

The camera shutter can close after the image has been recorded, for example after a specified delay time. Depending on requirements, the shutter can, however, also remain in the open position for a longer period of time, wherein the photosensor is exposed only by the illumination coming from the short-term illumination unit 6. This means that the triggering of the image recording can originate from the short-term illumination unit 6.

The at least one further image of the previously photographed region of the surface is transmitted to the evaluation unit 8 as a measuring state. Of course, it is possible to take a plurality of pictures at different rotational speeds or at the same rotational speed. The evaluation unit 8 then determines a strain of the rotor 2 in the photographed region of the surface using a digital image correlation. Here, the image of the surface in the starting state is used as a reference image with which the images of the measuring states, that is, the images under load of the rotor 2, are compared. Here, graphic elements that are generated by a natural surface structure of the rotor 2 or graphic elements that are components of a marking applied to the rotor surface can be used to bring a plurality of images into congruence with one another. Since it can be advantageous to store recordings of the substantially complete rotor surface as reference recordings or starting states, the graphic elements can be used to bring the recordings into congruence with one another by not only comparing the starting states and the measuring states, but also synchronising the starting states and the measuring states with one another. This results in a full-surface observation of the rotor 2. In addition, a rigid body motion can thereby be eliminated.

The graphic elements are also advantageous when the position of the camera 4 relative to the rotor 2 has been varied and pictures are taken of the rotor 2 from different positions or angles. Using the graphic elements, the different images can be brought into congruence with one another.

FIG. 2 schematically shows a delayed triggering of the illumination. By using a reference sensor 9 which is arranged at a distance from the rotor 2 and detects a reference mark in a contactless manner, for example on the surface of the rotor 2, the short-term illumination unit 6 can be controlled at a defined angle. The reference mark is detected once per revolution. A predeterminable angular offset is converted using the known rotational speed into a waiting period until the short-term illumination unit 6 is triggered and an image is recorded by the camera (not shown). As a result, the rotor 2 can be photographed by the camera in different angular positions. The recorded images can be synchronised with one another by means of recorded graphic elements that are present as markings on the rotor surface.

FIG. 3 shows an embodiment with a camera having a tilt adapter. It can be provided that the camera 4 has a tilt and shift adapter or a tilt adapter and/or a shift adapter 10. Alternatively, the camera 4 can have a tilt-shift lens 10. The adapters or the tilt-shift lens are shown by way of example in FIG. 3. Optimal illumination of the rotor 2 is achieved when the short-term illumination unit 6 is arranged relative to the rotor 2 in such a way that a surface of the rotor 2 facing the short-term illumination unit 6 is illuminated substantially uniformly. Here, the short-term illumination unit 6 is arranged in particular relative the rotor 2 in such a way that the light beams coming from the short-term illumination unit 6 strike the rotor surface substantially simultaneously, or a light cone coming from the short-term illumination unit 6 completely illuminates the surface of the rotor 2 facing said illumination unit. As can be seen from FIG. 3, the camera 4 can be aligned obliquely to the rotor 2 so that the short-term illumination unit 6 is not in the beam path of the camera 4. In order to achieve an inclined plane of focus, a tilt adapter 10 or the like can be used.

FIG. 4 shows an embodiment with two cameras. In this embodiment, too, the short-term illumination unit 6 is arranged centrally with respect to the rotor 2 in order to achieve uniform illumination of the rotor 2. In addition, the embodiment comprises a second camera 11 which, like the first camera 4, is arranged obliquely to the rotor 2 and, for example, has a tilt adapter 10. The cameras 4, 11 can be triggered simultaneously or one after the other. The triggering can take place in that the shutter of the camera 4, 11 is opened and the rotor 2 is briefly illuminated by the short-term illumination unit 6, by means of which the image sensor of the camera 4, 11 is exposed. In order to achieve simultaneous recordings of both cameras 4, 11, the shutters of both cameras 4, 11 are opened when the short-term illumination unit 6 is triggered and illuminates the rotor 2. The transit time of the light then ensures that the exposure of both image sensors is substantially exactly synchronised. The shutters of both cameras 4, 11 are then closed again. The closing of the shutters can also take place in an unsynchronised manner, wherein it is advantageous if this takes place after the end of the exposure of the image sensor or after the end of the illumination. By using the second camera 11, a 3D measurement is possible in which axial movements of the rotor 2, that is to say a lowering or raising of the rotor 2, can also be measured. This axial movement falsifies the strain measurement and can be detected by the preferred embodiment and eliminated from the calculation of the strain.

1. A method for measuring a strain of a rotor (2) loaded with centrifugal force, in which the rotor (2) is introduced into a receiving part (3) of a spin test rig (1) that can be connected to a drive, a camera (4) and a short-term laser as a short-term illumination unit (6) are triggered, and at least one region of a surface of the rotor (2) is photographed, and this first image is transmitted to an evaluation unit (8) as a starting state, the rotor (2) is accelerated and, at least one rotational speed, the camera (4) and the short-term laser as a short-term illumination unit (6) are triggered again and at least one further image of the previously photographed region of the surface is photographed, which is transmitted to the evaluation unit (8) as a measuring state, the evaluation unit (8) calculates a strain of the rotor (2) in the photographed region of the surface using a digital image correlation, wherein an exposure time of an image sensor of the camera (4) is determined from the duration of the illumination coming from the short-term laser (6).

2. The method according to claim 1, wherein a shutter of the camera (4) is brought into the open position before the rotating rotor (2) is photographed.

3. The method according to claim 1, wherein when a reference mark applied to the surface of the rotor or the rotor receiving part is detected by a reference sensor (9), the triggering process of the camera (4) and/or the short-term illumination unit (6) is started.

4. The method according to claim 1, wherein when a reference mark applied to the surface of the rotor (2) or the rotor receiving part is detected by a reference sensor (9), the triggering process of the camera (4) and/or the short-term illumination unit (6) is started with a delay.

5. The method according to claim 1, wherein the evaluation unit (8) compares images photographed in the measuring state with the image photographed in the starting state and calculates the strain of the rotor (2) based on displacements of an optically recognizable surface pattern in the photographed region of the surface.

6. The method according to claim 5, wherein the surface patterns are produced by a natural surface structure of the rotor (2).

7. The method according to claim 1, wherein graphic elements in the photographed region of a plurality of images are used to synchronize the images.

8. A device for measuring a strain of a rotor (2) loaded with centrifugal force, comprising a spin test rig (1) with receiving parts for receiving the rotor (2) that can be connected to a drive in a rotating manner, a camera (4) arranged at a distance from the rotor (2), which camera is arranged relative to the rotor (2) in such a way that images of at least one region of a surface of the rotor (2) can be photographed, and a short-term laser provided as a short-term illumination unit (6) for illuminating the rotor (2), wherein an exposure time of an image sensor of the camera (4) can be determined from the duration of the illumination coming from the short-term laser (6).

9. The device according to claim 8, wherein the device has positioning means which allow the position of the photo camera (4) to be changed relative to the rotor (2).

10. The device according to claim 8, wherein the device comprises a sensor (9) arranged at a distance from the rotor for detecting a reference mark applied to the rotor surface.

11. The device according to claim 8, wherein the camera (4) has a tilt and shift adapter or a tilt adapter and/or a shift adapter (10).

12. The device according to claim 8, wherein the camera (4) has a tilt-shift lens (10).

13. The device according to claim 8, wherein the device comprises a second camera (11).
